(19) United States
(12) Patent Application Publication
(10) Pub. No.: US 2026/0205009 A1
(43) Pub. Date: Jul. 16, 2026

(54) POWER CONVERSION DEVICE, ASSEMBLY PROCESS FLOW THEREOF, AND MAGNETIC ASSEMBLY

(71) Applicant: MetaPWR Electronics Co., Ltd., Shanghai (CN)

(72) Inventors: Da Jin, Shanghai (CN); Yahong Xiong, Shanghai (CN)

(73) Assignee: MetaPWR Electronics Co., Ltd., Shanghai (CN)

(21) Appl. No.: 19/444,210

(22) Filed: Jan. 9, 2026

(30) Foreign Application Priority Data
Jan. 10, 2025 (CN) 202510040207.X
Mar. 13, 2025 (CN) 202510293399.5

(51) Int. Cl. H02M 3/00; H02M 3/335

(52) U.S. Cl. CPC H02M 3/003; H02M 3/33569

(57) ABSTRACT

The present application is directed to a power conversion device, comprising a switch element, a magnetic core, a first substrate and a second substrate, wherein the magnetic core is assembled to the second substrate, and the switch element is disposed on the upper surface of the first substrate.

### CROSS-REFERENCE TO RELATED APPLICATION

This application claims the priority benefit of China application serial no. 202510040207.X, filed on January 10, 2025 and China application serial no 202510293399.5, filed on March 13, 2025. The entirety of the above-mentioned patent applications is hereby incorporated by reference herein and made a part of this specification.

### BACKGROUND

### Technical Field

The present invention relates to the technical field of high-frequency power supplies, and in particular, to a power conversion device, an assembly process flow thereof, and a magnetic assembly.

### Description of Related Art

With the development of artificial intelligence, the power requirements of intelligent data processing chips, such as GPU/CPU/NPU, etc. (collectively, xPU) are increasingly high, so that the power of the server is increased, the input voltage of the server gradually changes from 12V to 48V, and the operating voltage of the xPU is decreasing as the process progresses, and gradually moves from 0.8 V to 0.65 V. Therefore, the ratio of the input voltage to the output voltage becomes larger and larger, so that a two-stage buck circuit architecture gradually becomes the mainstream; the two-stage buck circuit architecture comprises a front-stage converter and a post-stage voltage regulator.

The present application discloses a power conversion device, used for a front-stage converter converting a 48V input voltage into an intermediate bus voltage, reducing the volume of the power conversion device by means of optimizing the winding manner of the transformer winding and the arrangement of the power device; and by means of optimizing the structure of the power conversion device, reducing the times that the device undergo reflow soldering, and reducing the production failure rate of the power conversion device.

### SUMMARY

In view of the above, one of the objectives of the application is to provide a power conversion device, comprising a switch, a magnetic core, a first substrate and a second substrate; the magnetic core comprises an upper magnetic cover, a lower magnetic cover, a first magnetic column and a second magnetic column; the second substrate comprises an upper surface and a lower surface opposite to each other, and holes; the holes penetrate through the upper surface and the lower surface of the second substrate and respectively allow the first magnetic column and the second magnetic column to pass through; the upper magnetic cover and the lower magnetic cover are respectively assembled from the upper surface and the lower surface of the second substrate;

the first substrate comprises a hollow part, an upper surface and a lower surface opposite to each other, the lower surface of the first substrate is disposed adjacent to the upper surface of the second substrate, and after the first substrate, the magnetic core and the second substrate are assembled, the upper magnetic cover of the magnetic core is exposed on the upper surface of the first substrate;

the switch is disposed on the upper surface of the first substrate.

Preferably, the power conversion device, further comprising an input positive terminal, an output positive terminal, a ground terminal, an input capacitor and an output capacitor, wherein the input positive terminal, the output positive terminal, the ground terminal and the input capacitor are all disposed on the lower surface of the second substrate; a positive electrode of the input capacitor is electrically connected to the input positive terminal, and a negative electrode of the input capacitor is electrically connected to the output positive terminal.

Preferably, the switch comprises an upper switch, a middle switch and a lower switch; the upper switch, the middle switch and the lower switch are sequentially connected in series and then connected between the input positive terminal and the ground terminal.

Preferably, the lower switch is further disposed on the lower surface of the second substrate, and a position of the lower switch disposed on the lower surface of the second substrate is in one-to-one correspondence with the position of the lower switch disposed on the upper surface of the first substrate.

Preferably, the magnetic core comprises a first side and a third side opposite to each other, a second side and a fourth side opposite to each other, a channel between the first magnetic column and the second magnetic column is a winding channel, and the winding channel penetrates the first side and the third side.

Preferably, the output capacitor is disposed on the upper surface of the first substrate and between the lower switch and the middle switch.

Preferably, the upper switch, the middle switch, and the lower switch are all disposed on the first side of the magnetic core, and the lower switch is adjacent to the first side of the magnetic core.

Preferably, the lower switch comprises two first lower switches and two second lower switches, the two second lower switches are disposed adjacent to the winding channel, and the two second lower switches are disposed between the two first lower switches.

Preferably, the lower surface of the first substrate is provided with an input positive terminal pad, and a drain of the upper switch is electrically connected to the input positive terminal pad through a via embedded in the first substrate; the upper surface of the second substrate is also provided with the input positive terminal pad, and the input positive terminal pad disposed on the upper surface of the second substrate is in one-to-one correspondence with the input positive terminal pad disposed on the lower surface of the first substrate.

Preferably, the upper switch comprises a first upper switch and a second upper switch; the middle switch comprises a first middle switch and a second middle switch; the lower switch comprises a first lower switch and a second lower switch; the first upper switch and the first middle switch are disposed along and adjoin the first side of the magnetic core; the second upper switch and the second middle switch are disposed along and adjoin the third side of the magnetic core; the first upper switch and the second upper switch are both disposed adjacent to the second side of the magnetic core, and both the first middle switch and the second middle switch are disposed adjacent to the fourth side of the magnetic core.

Preferably, one of first lower switches and one of second lower switches form a lower switch assembly, and the lower switch assembly comprises a first lower switch assembly and a second lower switch assembly; the first lower switch assembly is disposed along and adjoin the second side of the magnetic core, and the second lower switch assembly is disposed along and adjoin the fourth side of the magnetic core; the first lower switch in each lower switch assembly is disposed adjacent to the third side of the magnetic core, and the second lower switch in each lower switch assembly is disposed adjacent to the first side of the magnetic core.

Preferably, each of the first magnetic column and the second magnetic column comprises an inner side and an outer side; the second side of the magnetic core adjoins the outer side of the first magnetic column, and the fourth side of the magnetic core adjoins the outer side of the second magnetic column; and the first lower switch assembly, the first magnetic column, the second magnetic column, and the second lower switch assembly are disposed in side-by-side and adjoin each other.

Preferably, the output capacitor respectively adjoins sources of the first lower switch assembly and the second lower switch assembly; the output capacitor, the first lower switch assembly, the first magnetic column, the second magnetic column, the second lower switch assembly, and the output capacitor are disposed in side-by-side and are adjoins each other.

Preferably, the lower surface of the second substrate is provided with a third lower switch assembly and a fourth lower switch assembly, and the third lower switch assembly and the fourth lower switch assembly are respectively vertically corresponding to the first lower switch assembly and the second lower switch assembly.

Preferably, the hollow part is a hollow groove disposed adjacent to one of sides of the first substrate.

Preferably, the hollow part is a hollow hole located at a position close to a center of the first substrate.

Preferably, the power conversion device, further comprising a third substrate, wherein the third substrate comprises an upper surface and a lower surface opposite to each other; the upper surface of the third substrate is disposed adjacent to the lower surface of the second substrate; the upper surface of the third substrate is provided with a pin pad, the pin pad is electrically connected to the input positive terminal, the output positive terminal, and the ground terminal; the lower surface of the third substrate is provided with a pin, and the pin is used for being electrically connected to an external assembly.

An assembly process flow of the power conversion device, comprising the following steps:

step 1: welding a device on the lower surface of the second substrate, and assembling the magnetic core; meanwhile, completing assembly of the third substrate; and assembling all devices on the upper surface of the first substrate together using SMD;

step 2: the assembled second substrate of step 1 and the third substrate are assembled together using SMD;

step 3: an assembly assembled by step 2 and an assembly assembled by step 1 are welded together using SMD.

A power conversion device, comprising an input&output terminal, a switch, an output capacitor, and a magnetic assembly; the input&output terminal comprises an input positive terminal, an output positive terminal and a ground terminal, and the output capacitor is connected across the output positive terminal and the ground terminal; the switch comprises an upper switch, a middle switch and a lower switch; the upper switch comprises a first upper switch and a second upper switch; the middle switch comprises a first middle switch and a second middle switch; the lower switch comprises a first lower switch and a second lower switch;

the first upper switch, the first middle switch and the first lower switch constitute a first three-switch bridge arm, the first upper switch and the first middle switch are electrically connected to a first upper node, and the first middle switch and the first lower switch are electrically connected to a first lower node; the second upper switch, the second middle switch and the second lower switch constitute a second three-switch bridge arm, the second upper switch and the second middle switch are electrically connected to a second upper node, and the second middle switch and the second lower switch are electrically connected to a second lower node; the magnetic assembly is at least electrically connected to the first lower node, the second lower node, and the output positive terminal;

wherein the power conversion device further comprises a first substrate, the upper switch, the middle switch, the lower switch, and the output capacitor are disposed on the first substrate, and the output capacitor is disposed between the lower switch and the middle switch.

Preferably, the magnetic assembly comprises a magnetic core and a winding; the magnetic core comprises a first magnetic column and a second magnetic column, a channel between the first magnetic column and the second magnetic column is a winding channel, and the winding channel penetrates two opposite sides of the magnetic core; the winding passes through the winding channel, and the lower switch is disposed adjacent to the winding channel.

Preferably, the magnetic core comprises an upper magnetic cover and a lower magnetic cover; the winding comprises a first high-voltage winding, a second high-voltage winding, a first low-voltage winding, and a second low-voltage winding; each of the first high-voltage winding, the second high-voltage winding, the first low-voltage winding, and the second low-voltage winding comprises a first end and a second end; the second end of the first low-voltage winding is electrically connected to the second end of the second low-voltage winding.

Preferably, the second end of the first high-voltage winding is electrically connected to the first end of the second low-voltage winding; the second end of the second high-voltage winding is electrically connected to the first end of the first low-voltage winding.

Preferably, each of the first high-voltage winding, the second high-voltage winding, the first low-voltage winding and the second low-voltage winding is wound around the first magnetic column and the second magnetic column, and a winding direction on the first magnetic column is opposite to a winding direction on the second magnetic column; a winding direction of the first high-voltage winding is opposite to a winding direction of the second high-voltage winding on a same magnetic column of the first and second magnetic columns, and a winding direction of the first low-voltage winding is opposite to a winding direction of the second low-voltage winding on a same magnetic column of the first and second magnetic columns.

Preferably, the switch and the input&output terminal are disposed on different planes; a setting position of the input positive terminal is in one-to-one correspondence with a setting position of the upper switch; a setting position of the ground terminal is in one-to-one correspondence with a setting position of the lower switch.

Preferably, the power conversion device, further comprising an input capacitor, wherein a setting position of the input capacitor is in one-to-one correspondence with a setting position of the upper switch.

A magnetic assembly, comprising a magnetic core, a first high-voltage winding, a second high-voltage winding, a first low-voltage winding, and a second low-voltage winding; each of the first high-voltage winding, the second high-voltage winding, the first low-voltage winding, and the second low-voltage winding comprises a first end and a second end; the second end of the first low-voltage winding is electrically connected to the second end of the second low-voltage winding; the magnetic core comprises an upper magnetic cover, a lower magnetic cover, a first magnetic column and a second magnetic column; each of the first high-voltage winding, the second high-voltage winding, the first low-voltage winding and the second low-voltage winding is wound around the first magnetic column and the second magnetic column, and a winding direction on the first magnetic column is opposite to a winding direction on the second magnetic column; a winding direction of the first high-voltage winding is opposite to a winding direction of the second high-voltage winding on a same magnetic column of the first magnetic column and the second magnetic column, and a winding direction of the first low-voltage winding is opposite to a winding direction of the second low-voltage winding on a same magnetic column of the first magnetic column and the second magnetic column.

Preferably, the magnetic core comprises a first side and a third side opposite to each other, a second side and a fourth side opposite to each other; a channel between the first magnetic column and the second magnetic column is a winding channel, and the winding channel penetrates the first side and the third side.

Preferably, the first end and the second end of each of the first high-voltage winding, the second high-voltage winding, the first low-voltage winding, and the second low-voltage winding are disposed adjacent to a same side of the magnetic core.

Preferably, a winding method from the first end to the second end of the first low-voltage winding is: firstly, the first low-voltage winding is divided into two paths, respectively surrounding the magnetic core from two sides of the magnetic core, and reaching the third side of the magnetic core from the first side of the magnetic core; then after converging, passing through the winding channel from the third side of the magnetic core to the first side of the magnetic core.

Preferably, a winding method from the first end to the second end of the second low-voltage winding is: firstly, passing through the winding channel from the first side of the magnetic core, reaching the third side of the magnetic core, then the second low-voltage winding is divided into two paths, respectively surrounding the magnetic core from two sides of the magnetic core, reaching the first side of the magnetic core.

Preferably,n the first and second high-voltage windings and the first and second low-voltage windings are disposed on a substrate; a winding method from the first end to the second end of the first high-voltage winding is: firstly, on a first layer of the substrate, passing through the winding channel from the first side to the third side of the magnetic core, then the first high-voltage winding is divided into two paths, respectively surrounding the magnetic core from two sides of the magnetic core, returning to the first side of the magnetic core, and then reaching a second layer of the substrate through a via; on the second layer, passing through the winding channel from the first side of the magnetic core to the third side of the magnetic core, then the first high-voltage winding is divided into two paths, respectively surrounding the magnetic core from two sides of the magnetic core, returning to the first side of the magnetic core.

Preferably, a winding method from the first end to the second end of the second high-voltage winding is: firstly, on a third layer of the substrate, the second high-voltage winding is divided into two paths, respectively surrounding the magnetic core from two sides of the magnetic core, reaching the third side of the magnetic core from the first side of the magnetic core; then after converging, passing through the winding channel from the third side of the magnetic core to the first side of the magnetic core, and then reaching to a fourth layer of the substrate through a via; on the fourth layer, the second high-voltage winding is divided into two paths, respectively surrounding the magnetic core from two sides of the magnetic core, reaching the third side of the magnetic core from the first side of the magnetic core; then after converging, passing through the winding channel again from the third side of the magnetic core to the first side of the magnetic core.

Preferably, the first end of the first low-voltage winding is located on the second side and the fourth side of the magnetic core; the second end of the first low-voltage winding is located on the second side and the fourth side of the magnetic core; the first end of the second low-voltage winding is located on the second side and the fourth side of the magnetic core; and the second end of the second low-voltage winding is located on the second side and the fourth side of the magnetic core.

Preferably, the first end of the first high-voltage winding adjoins the winding channel on the first side of the magnetic core; the first end of the second high-voltage winding adjoins the winding channel of the third side of the magnetic core; the second end of the first high-voltage winding respectively adjoins the second side of the magnetic core and the fourth side of the magnetic core; and the second end of the second high-voltage winding respectively adjoins the second side of the magnetic core and the fourth side of the magnetic core.

Preferably, a winding method from the first end to the second end of the first low-voltage winding is: from the second side of the magnetic core and the fourth side of the magnetic core respectively and along the third side, the first low-voltage winding is converged at an opening of the winding channel of the third side of the magnetic core, passing through the winding channel and reaching the first side of the magnetic core; and then, the first low-voltage winding is divided into two paths and reaching the second side and the fourth side of the magnetic core respectively along the first side of the magnetic core.

Preferably, a winding method from the first end to the second end of the first low-voltage winding is: from the second side and the fourth side of the magnetic core respectively and along the first side of the magnetic core, the first low-voltage winding is converged at the opening of the winding channel of the first side of the magnetic core, passing through the winding channel and reaching the third side of the magnetic core; and then, the first low-voltage winding is divided into two paths, reaching the second side and the fourth side of the magnetic core respectively along the third side of the magnetic core.

Preferably, a winding method from the first end to the second end of the first high-voltage winding is: firstly, passing through the winding channel from bottom to top, and then the first high-voltage winding is divided into two branches, wherein one of the branches is wound around the first magnetic column in a counterclockwise direction for at least one circle, then reaching and adjoining the second side of the magnetic core; the other branch is wound around the second magnetic column in a clockwise direction for at least one circle, then reaching and adjoining the fourth side of the magnetic core.

Preferably, a winding method from the first end to the second end of the second high-voltage winding is: firstly, passing through the winding channel from top to bottom, then dividing into two branches, one of the branches of the winding channel is wound around the first magnetic column in the clockwise direction for at least one circle, then reaching and adjoining the second side of the magnetic core; the other branch of the winding channel is wound around the second magnetic column in the counterclockwise direction for at least one circle, then reaching and adjoining the fourth side of the magnetic core.

Preferably, the second end of the first high-voltage winding is connected to the first end of the second low-voltage winding; and the second end of the second high-voltage winding is connected to the first end of the first low-voltage winding.

Compared with the prior art, the application has the following beneficial effects:

(1) The present application is directed to a power conversion device, comprising a switching element, a magnetic core, a first substrate and a second substrate, wherein the magnetic core is assembled to the second substrate, and the switching element is disposed on an upper surface of the first substrate; by providing the hollow part on the first substrate, an upper magnetic cover of the magnetic core is exposed, thereby reducing the height difference between the switching element and the magnetic core on a top surface of the power conversion device ; further reducing the upward thermal resistance of the power conversion device, improving the heat dissipation capability of the power conversion device; reducing the loss on the magnetic core, and improving the conversion efficiency of the power conversion device;.

(2) By disposing an output capacitor between a lower switch assembly and the upper/middle switch assembly, a power loop of the power conversion device is further reduced, and the conversion efficiency of the power conversion device is improved.

(3) By optimizing the structure of the power conversion device, times that the device undergo reflow soldering in the device assembly process is reduced, and the production efficiency and yield are improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a power conversion circuit;

FIG. 2A to FIG. 2C are three-dimensional schematic diagrams of a power conversion device;

FIG. 3A and FIG. 3B are winding manners of a high-voltage winding;

FIG. 3C and FIG. 3D are winding manners of a low-voltage winding;

FIG. 4A to FIG. 4C are three-dimensional schematic diagrams of a power conversion device in an extended embodiment;

FIG. 5A and FIG. 5B are winding manners of a high-voltage winding; and

FIG. 5C and FIG. 5D are winding manners of the low-voltage winding.

### DESCRIPTION OF THE EMBODIMENTS

One of the cores of the present application is to provide a power conversion device, including a structure and a control/driving mode of the power conversion device.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

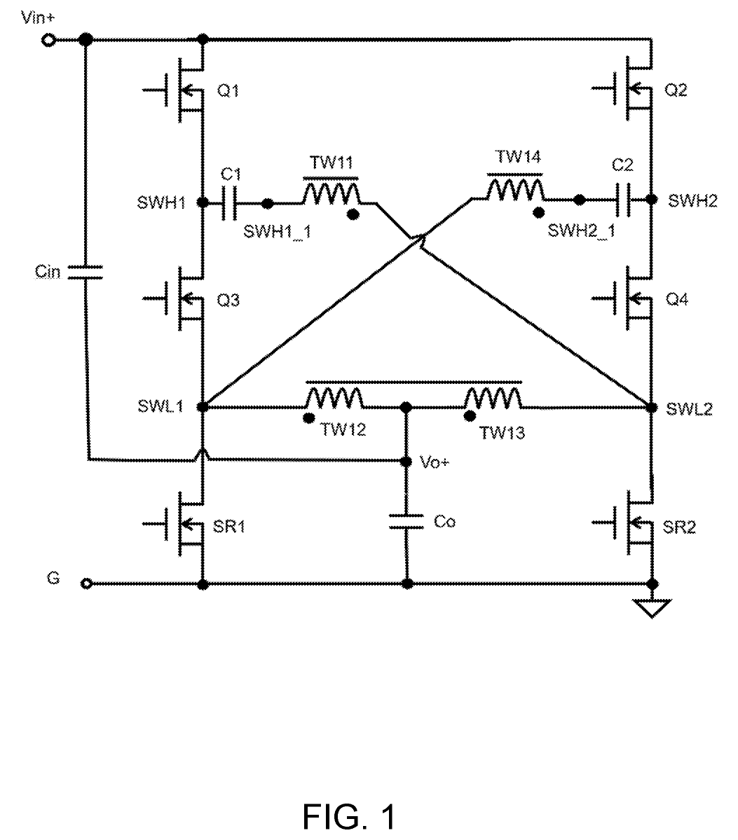

A power conversion circuit disclosed in the present application is shown in FIG. 1 and is a non-isolated power conversion circuit topology. The non-isolated power conversion circuit comprises an input end, an output end, a first sub-circuit, a second sub-circuit, a magnetic assembly and a resonant capacitor; the input end comprises an input positive end Vin+ and an input negative end Vin-, and the output end comprises an output positive end Vo+ and an output negative end Vo-. In the present embodiment, the input negative end Vin- and the output negative end Vo- are shorted (i.e. a ground end G); each sub-circuit includes an upper switch, a middle switch, and a lower switch that are sequentially connected in series. The first sub-circuit comprises the upper switch Q1, the middle switch Q3 and the lower switch SR1 that are sequentially connected in series; the second sub-circuit comprises the upper switch Q2, the middle switch Q4, and the lower switch SR2 that are sequentially connected in series, wherein the upper switch Q1 is connected between the input positive terminal Vin+ and a first upper node SWH1, the middle switch Q3 is connected between the first upper node SWH1 and a first lower node SWL1, and the lower switch SR1 is connected between the first lower node SWL1 and the input negative end Vin-. The upper switch Q2 is connected between the input positive end Vin+ and a second upper node SWH2, the middle switch Q4 is connected between the second upper node SWH2 and a second lower node SWL2, and the lower switch SR2 is connected between the second lower node SWL2 and the input negative end Vin-. The magnetic assembly comprises a first high-voltage winding TW11, a second high-voltage winding TW14, a first low-voltage winding TW12, and a second low-voltage winding TW13. The first high-voltage winding TW11 and the resonant capacitor C1 are electrically connected in series to a connection point SWH1_1, and the first high-voltage winding TW11 and the resonant capacitor C1 are connected in series to form a series branch, and the series branch is connected between the first upper node SWH1 and the second lower node SWL2. The second high-voltage winding TW14 and the resonant capacitor C2 are electrically connected in series to a connection point SWH2_1, and the second high-voltage winding TW14 and the resonant capacitor C2 are connected in series to form a series branch, and the series branch is connected between the second upper node SWH2 and the first lower node SWL1.

A second end of the first low-voltage winding TW12 and a second end of the second low-voltage winding TW13 are electrically connected to the output positive end Vo+; a first end of the first low-voltage winding TW12 is electrically connected to the first lower node SWL1, a first end of the second low-voltage winding TW13 is electrically connected to the second lower node SWL2. The power conversion circuit further comprises an input capacitor Cin and an output capacitor Co, the input capacitor Cin is connected between the input positive end Vin+ and the output positive end Vo+, and the output capacitor Co is connected between the output positive end Vo+ and the output negative end Vo-. A second end i.e. the second lower node SWL2) of the first high-voltage winding TW11, a first end (i.e. the connection point SWH2_1) of the second high-voltage winding TW14, the first end (i.e. the first lower node SWL1) of the first low-voltage winding TW12 and the second end (i.e. the output positive end Vo+) of the second low-voltage winding TW13 have the same polarity, and are labeled as point ends. The first high-voltage winding TW11, the second high-voltage winding TW12, the first low-voltage winding TW12 and the second low-voltage winding TW13 are all coupled to the same magnetic core to form coupling windings of the transformer.

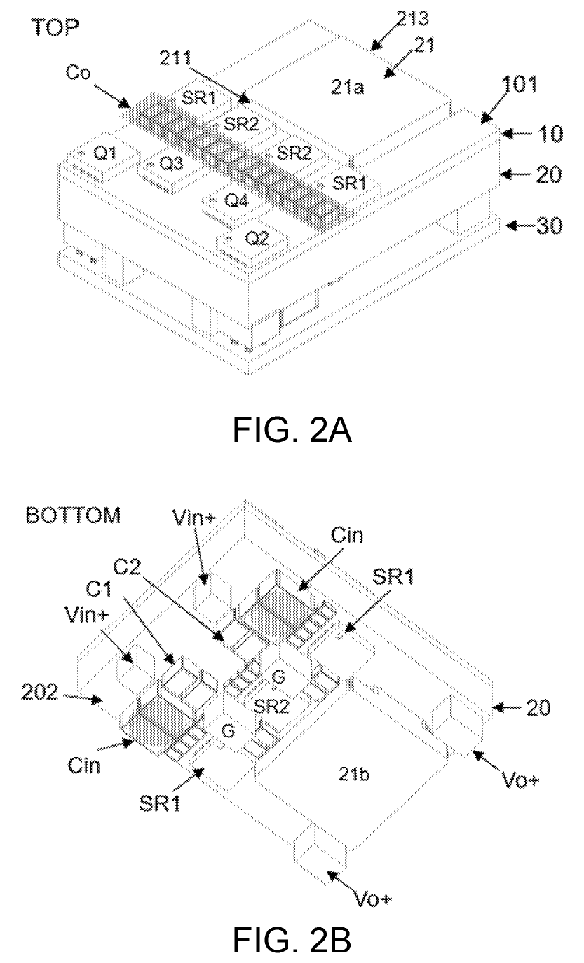

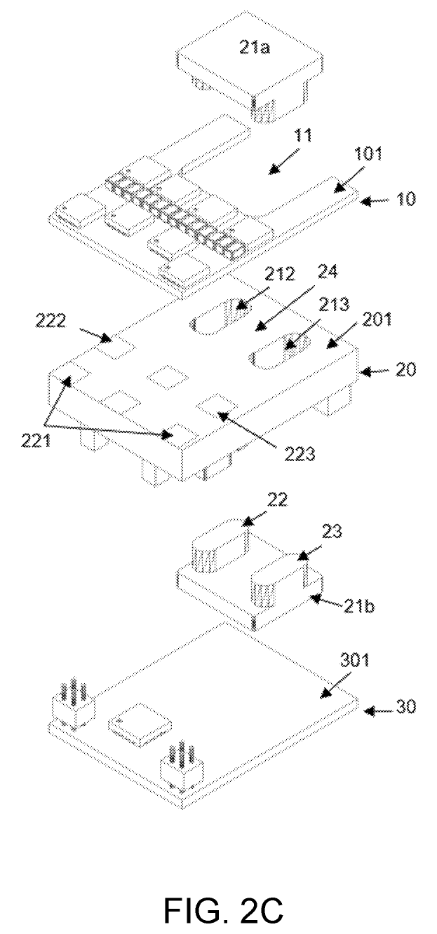

A schematic structural diagram of a power conversion device using the power conversion circuit shown in FIG. 1 is shown in FIG. 2A to FIG. 2C, FIG. 2A is a top view of the power conversion device, FIG. 2B is a bottom view of the power conversion device, and FIG. 2C is an exploded view of the power conversion device. With reference to FIGS. 2A-FIG. 2C, the power conversion device comprises a first substrate 10, a second substrate 20 and a third substrate 30; each substrate comprises an upper surface and a lower surface opposite to each other, the lower surface of the first substrate 10 and the upper surface 201 of the second substrate 20 are adjacent to each other, and the lower surface of the second substrate 20 and the upper surface 301 of the third substrate 30 are adjacent to each other. A magnetic core 21 comprises an upper magnetic cover 21a, a lower magnetic cover 21b, a first magnetic column 22 and a second magnetic column 23; the second substrate 20 comprises holes 212 and 213 for respectively allowing the first magnetic column 22 and the second magnetic column 23 to pass through, such that the magnetic core 21 is assembled to the second substrate 20. After the magnetic core 21 is assembled to the second substrate 20, the magnetic core 21 comprises a first side 211 and a third side 213 opposite to each other, and a second side and a fourth side opposite to each other; The channel between the magnetic columns 22 and 23 is a winding channel 24. The winding channel 24 penetrates the first side 211 and the third side 213. The first substrate 10 comprises a hollow groove 11, and the hollow groove 11 is disposed adjacent to one side of the first substrate 10. After the first substrate 10 and the second substrate 20 are assembled, the upper magnetic cover 21a of the magnetic core 21 is exposed by means of the hollow groove 11.

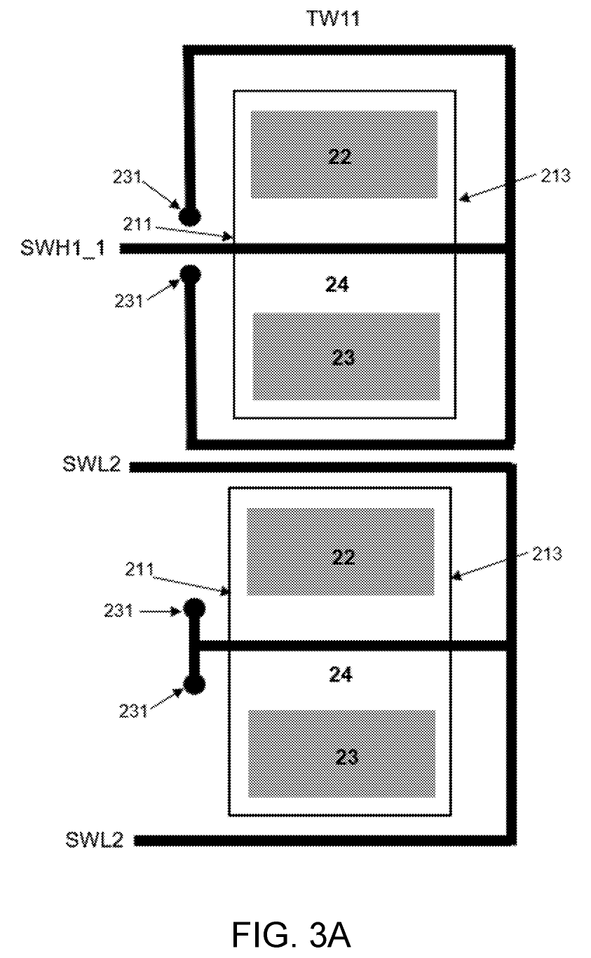

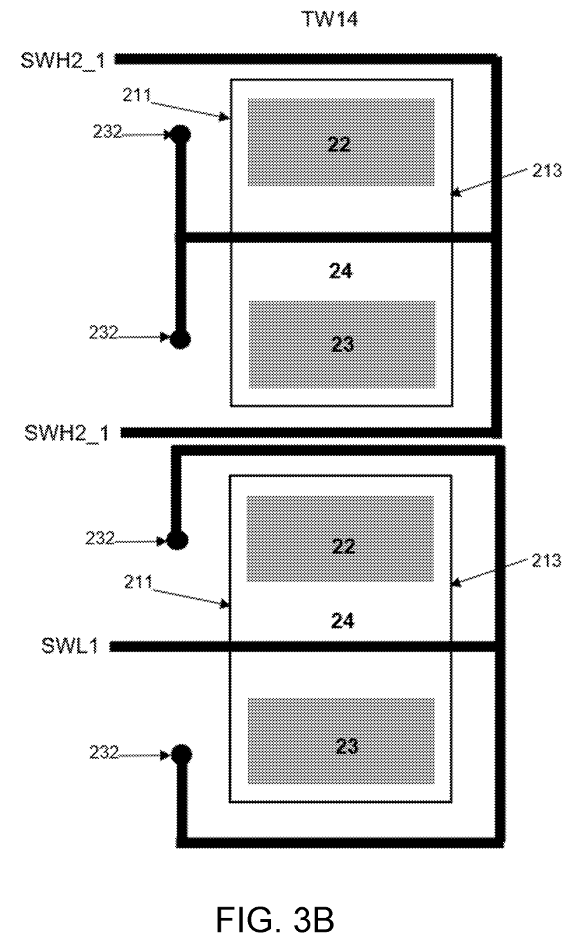

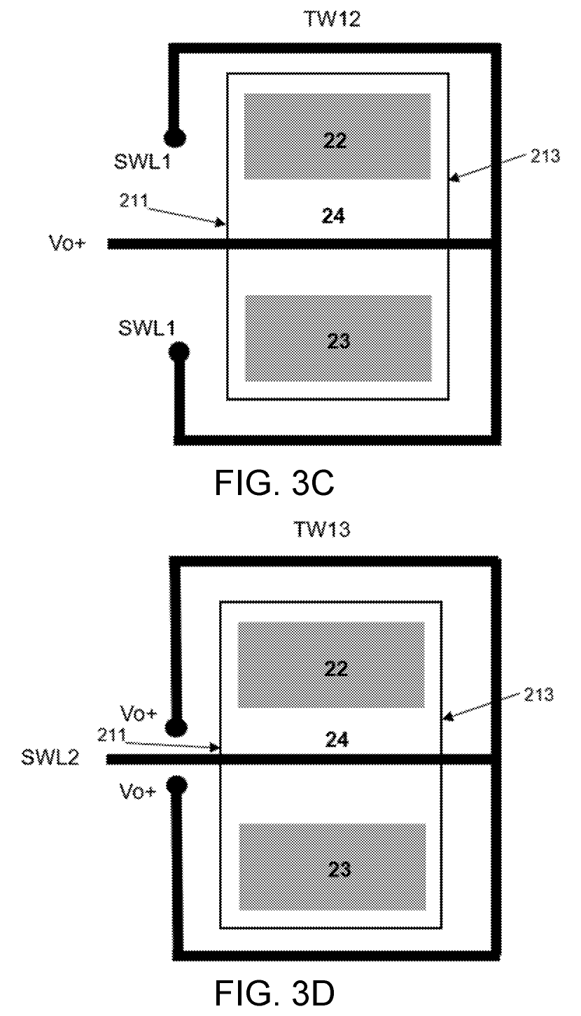

The upper switch Q1&Q2, the middle switch Q3&Q4 and the lower switch SR1&SR2 are all disposed on the upper surface 101 of the first substrate 10 and are all disposed on the first side 211 of the magnetic core 21; an upper&middle switch assembly includes the upper switch Q1&Q2 and the middle switch Q3&Q4, and a lower switch assembly includes the lower switch SR1/SR2. The lower switch assembly disposed adjacent to the first side 211 of the magnetic core 21; the lower switch SR2 is disposed adjacent to the winding channel 24 of the magnetic core 21, and the two second lower switches SR2 are disposed between the two first lower switches SR1. The output capacitor Co is disposed between the upper/middle switch assembly and the lower switch assembly such that the loop is minimum which comprising the lower switch assembly, the first low-voltage winding TW12, the second low-voltage winding TW13 and the output capacitor Co. Meanwhile, referring to a winding manner of the first low-voltage winding TW12 and the second low-voltage winding TW13 shown in FIG. 3C and 3D, a drain of the first lower switch SR1 and a source of the first middle switch Q3 are electrically connected to the first lower node SWL1, and a winding method of the first low-voltage winding TW12 from the first end (i.e. the first lower node SWL1) to the second end (i.e. the output positive end Vo+) is: firstly, the winding is divided into two paths, respectively surrounding the magnetic core 21 from two sides of the magnetic core 21, and reaching the third side 213 of the magnetic core from the first side 211 of the magnetic core; then after converging, passing through the winding channel 24 from the third side 213 of the magnetic core to the first side 211 of the magnetic core, thereby reaching the output positive end Vo+; the first end and the second end of the first low-voltage winding TW12 are both disposed adjacent to the first side 211 of the magnetic core. A drain of the second lower switch SR2 and a source of the second middle switch Q4 are electrically connected to the second lower node SWL2, and a winding method of the second low-voltage winding TW13 from the first end (i.e. the second lower node SWL2) to the second end (i.e. the output positive end Vo+) is: firstly, passing through the winding channel 24 from the first side 211 of the magnetic core, reaching the third side 213 of the magnetic core, then the winding is divided into two paths, respectively surrounding the magnetic core 21 from two sides of the magnetic core 21, reaching the first side 211 of the magnetic core. A source of the first lower switch SR1 and a source of the second lower switch SR2 are both electrically connected to a negative end of the output capacitor and to the ground end G; one side of the output capacitor Co adjacent to the lower switch assembly is a ground network, and the ground network is connected to the source of the lower switch nearby, thereby the power loop of the device is shortened.

A drain of the upper switch Q1/Q2 is electrically connected to a Vin+ pad provided on the lower surface of the first substrate 10 through a via embedded in the first substrate 10. Correspondingly, the upper surface of the second substrate 20 is also provided with a Vin+ pad 221, and the Vin+ pad 221 is in one-to-one correspondence with the Vin+ pad provided on the lower surface of the first substrate 10. The lower surface of the second substrate 20 is provided with the input capacitor Cin, a positive end of the input capacitor Cin is electrically connected to the Vin+ pad 221, and a negative end of the input capacitor Cin is electrically connected to the output positive end Vo+. A source of the first upper switch Q1 and a drain of the first middle switch Q3 are electrically connected to the first upper node SWH1, and the first upper node SWH1 is electrically connected to a first upper node pad on the lower surface of the first substrate 10 through the via in the first substrate 10. Correspondingly, the upper surface of the second substrate 20 is also provided with a first upper node pad 222, and the first upper node pad 222 is in one-to-one correspondence with the first upper node pad provided on the lower surface of the first substrate 10. The lower surface of the second substrate is provided with the resonant capacitor C1, one end of the resonant capacitor C1 is electrically connected to the first upper node pad 222, and the other end of the resonant capacitor C1 is electrically connected to the first end of the first high-voltage winding TW11. A source of the second upper switch Q2 and a drain of the second middle switch Q4 are electrically connected to the second upper node SWH2, and the second upper node SWH2 is electrically connected to a second upper node pad on the lower surface of the first substrate 10 through a via in the first substrate 10; and correspondingly, the upper surface of the second substrate 20 is also provided with a second upper node pad 223, and the second upper node pad 223 is in one-to-one correspondence with the second upper node pad provided on the lower surface of the first substrate 10. The lower surface of the second substrate is provided with the resonant capacitor C2, one end of the resonant capacitor C2 is electrically connected to the second upper node pad 223, and the other end of the resonant capacitor C2 is electrically connected to the first end of the second high-voltage winding TW14. Meanwhile, referring to a winding manner of the first high-voltage winding TW11 shown in FIG. 3A, and a winding manner of the second high-voltage winding TW14 shown in FIG. 3B; the winding method of the first high-voltage winding TW11 from the first end (i.e. the connection point SWH1_1) to the second end (i.e. the second lower node SWL2) is: firstly, on a first layer of the second substrate 20, passing through the winding channel 24 from the first side 211 of the magnetic core to the third side 213 of the magnetic core, then the winding is divided into two paths, respectively surrounding the magnetic core 21 from two sides of the magnetic core 21, returning to the first side 211 of the magnetic core, and then reaching a second layer of the second substrate 20 through the via 231; on the second layer, passing through the winding channel 24 from the first side 211 of the magnetic core to the third side 213 of the magnetic core, then the winding is divided into two paths, respectively surrounding the magnetic core 21 from two sides of the magnetic core 21, returning to the first side 211 of the magnetic core, and reaching the second lower node SWL2. The winding method of the second high-voltage winding TW14 from the first end (i.e. the connection point SWH2_1) to the second end (i.e. the first lower node SWL1) is: firstly, on a third layer of the second substrate 20, the winding is divided into two paths, respectively surrounding the magnetic core 21 from two sides of the magnetic core 21, reaching the third side 213 of the magnetic core from the first side 211 of the magnetic core ;then after converging, passing through the winding channel 24 from the third side 213 to the first side 211 of the magnetic core, and then through the via 232 to a fourth layer of the second substrate 20; on the fourth layer, the winding is divided into two paths, respectively surrounding the magnetic core 21 from two sides of the magnetic core 21, reaching the third side213 of the magnetic core from the first side 211 of the magnetic core; after converging, passing through the winding channel 24 from the third side to the first side 211 of the magnetic core, reaching the first lower node SWL1.

In the present embodiment, the winding directions of the first high-voltage winding TW11 and the second high-voltage winding TW14 around the same U-shaped magnetic core are opposite, and the winding directions of the first low-voltage winding TW12 and the second low-voltage winding TW13 around the same U-shaped magnetic core are opposite, thereby reducing the volume and the loss of the magnetic core, and further improving the conversion efficiency of the power conversion device. The first layer, the second layer, the third layer, and the fourth layer herein are only described on different layers of the second substrate 20, and do not represent the arrangement order of the specific layers. Moreover, the number of turns of the high-voltage winding is not limited to two circles, as long as at least two circles are wound in the same winding manner. The low-voltage winding may also be disposed on the plurality of wiring layers of the second substrate 20, and are electrically connected in parallel through the vias, thereby the parasitic resistance loss generated by the current flowing through the low-voltage winding is reduced, and further the conversion efficiency of the power conversion device is improved.

The lower surface of the second substrate 20 is further provided with the input capacitor Cin, and the input positive terminal Vin +, the ground terminal G, the output positive terminal Vo+, the first lower switch SR1, and the second lower switch SR2. The positions of a part of the input capacitors have a one-to-one correspondence to the positions of the first upper switch Q1, and "one-to-one correspondence" herein means that the projections of the first upper switch Q1 and the part of the input capacitors Cin on the lower surface of the second substrate 20 are at least partially overlapped, and the definitions of the following "one-to-one" are all of this kind; and the position of the other part of the input capacitors Cin is in one-to-one correspondence with the position of the second upper switch Q2. The position of the resonant capacitor C1 is in one-to-one correspondence with the position of the first middle switch Q3. The position of the resonant capacitor C2 is in one-to-one correspondence with the position of the second middle switch Q4. The positions of the two input positive terminals Vin+ are respectively in one-to-one correspondence with the position of the first upper switch Q1 and the position of the second upper switch Q2; the two output positive terminals Vo+ are respectively disposed on the second side and the third side of the magnetic core, and are symmetrically placed along the magnetic core. The position of the first lower switch SR1 provided on the lower surface of the second substrate 20 is in one-to-one correspondence with the position of the first lower switch SR1 provided on the upper surface of the first substrate 10. The position of the second lower switch SR2 provided on the lower surface of the second substrate 20 is in one-to-one correspondence with the position of the second lower switch SR2 provided on the upper surface of the first substrate 10. And the ground terminal G and the first lower switch or the second lower switch are disposed in a staggered manner, and the order is sequentially the first lower switch SR2, the ground terminal G, the second lower switch SR1, the ground terminal G, and the first lower switch SR2. The input positive terminal Vin+, the output positive terminal Vo+ and the ground terminal G disclosed in this embodiment may be metal columns, with copper columns being the best choice, but this is not limited to this.

The third substrate 30 comprises the upper surface and the lower surface opposite to each other, wherein the upper surface 301 is provided with other auxiliary circuits such as a pin pad, a controller, and a driver; the pin pad is used for being fixed and electrically connected to the input positive terminal, the output positive terminal and the ground terminal; and the lower surface of the third substrate 30 is provided with a pin for being electrically connected to an external assembly.

According to the power conversion device structure disclosed in this embodiment, during assembling, the structure may be performed according to the following steps:

Step 1: Welding a component on the lower surface of the second substrate, and completing the assembly of the magnetic core; and assembling all components on the upper surface of the first substrate together using SMD;

Step 2: The assembled second substrate of Step 1 and the third substrate are assembled together using SMD;

Step 3: The assembly of Step 2 and the assembly of Step 1 are welded together using SMD.

By means of the device structure and assembly steps disclosed in the present application, the times that a component passes the SMD is at most three, thereby reducing the influence on device reliability caused by multiple reflow soldering at a high temperature during assembly, and improving the production yield of the power conversion device. According to the device structure disclosed in the present application, pads are provided on both the lower surface of the first substrate 10 and the upper surface of the second substrate 20, and the pads on the lower surface of the first substrate 10 are in one-to-one correspondence with the pads on the upper surface of the second substrate 20, and the electrical networks are also in one-to-one correspondence. By means of the hollow groove provided by the first substrate 10, the upper magnetic cover of the magnetic core is exposed, so that the height difference of the top surface of the power conversion device can be reduced, herein the height difference is between the switch element and the magnetic core; the thermal resistance in the power conversion device is further reduced, the heat dissipation capability of the power conversion device is improved; the loss on the magnetic core is reduced, and the conversion efficiency of the power conversion device is improved.

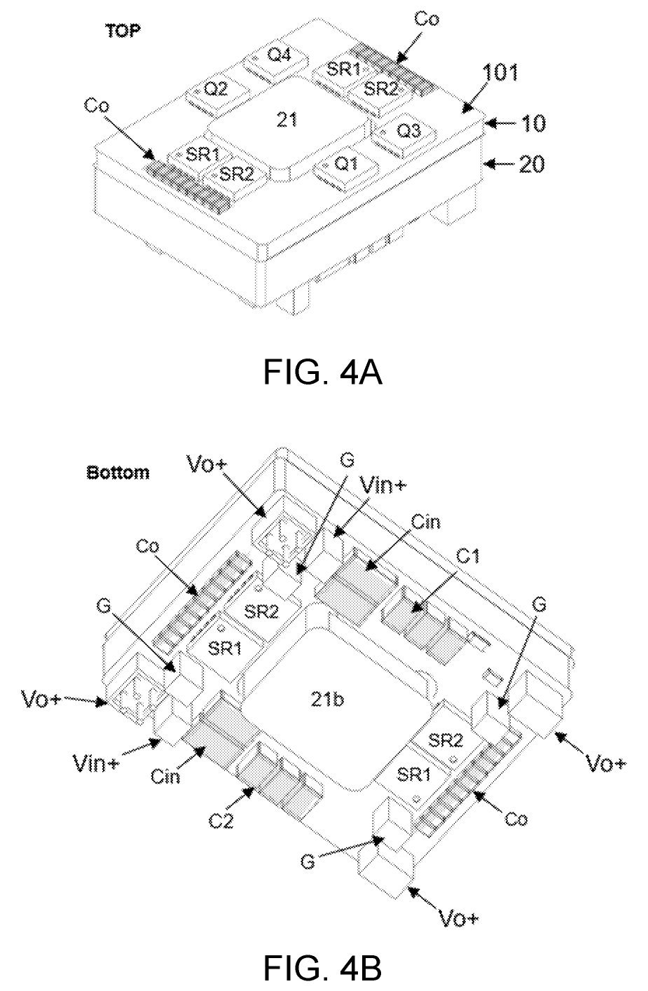

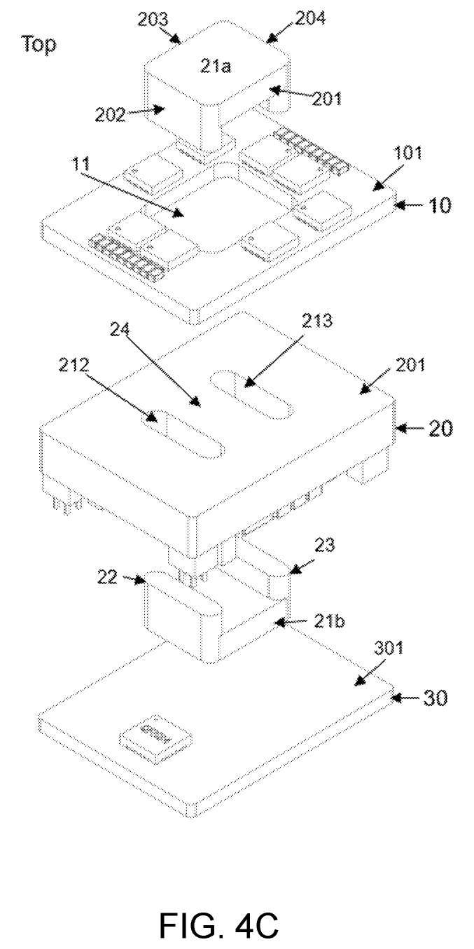

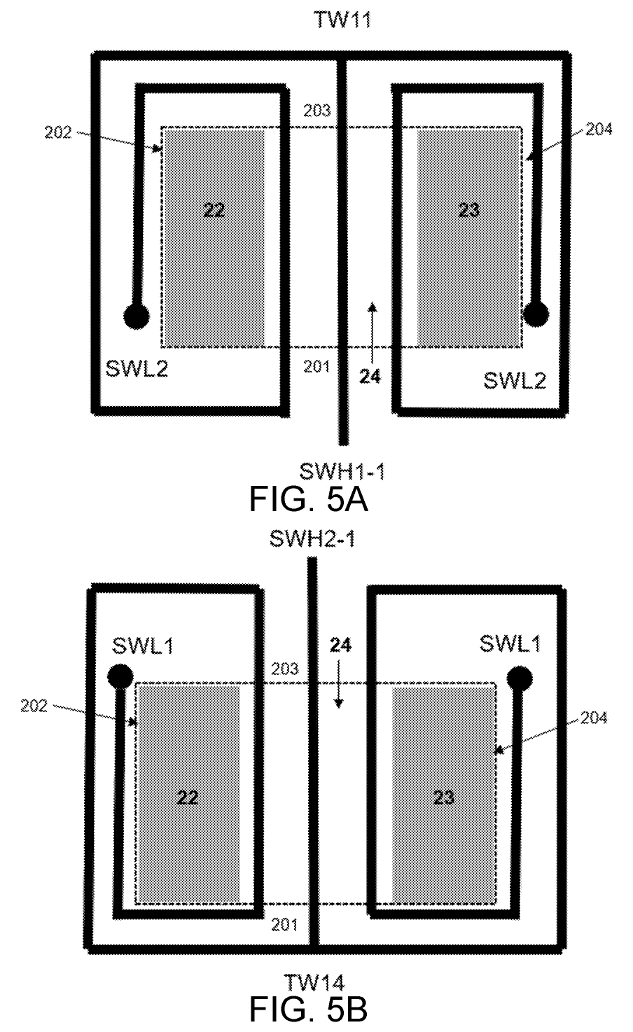

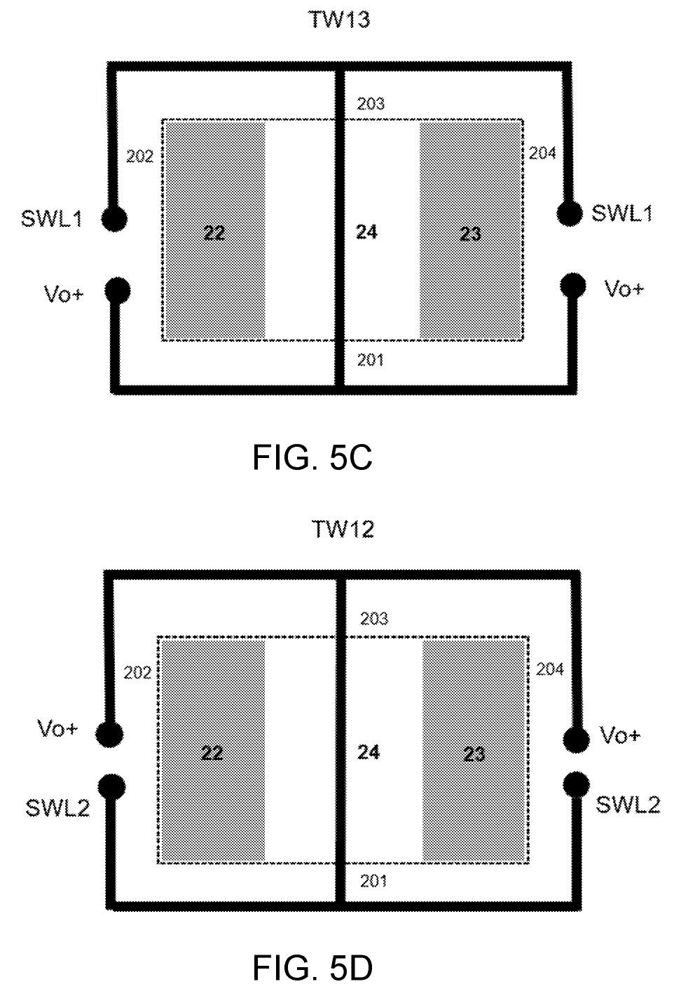

Another embodiment of the power conversion device is also disclosed, as shown in FIG. 4A to FIG. 5D. FIG. 4A to FIG. 4C are structures of the power conversion device, and FIG. 5A to FIG. 5D are winding manners of the winding. With reference to FIG. 4A to 4C, the power conversion device comprises the first substrate 10, the second substrate 20 and the third substrate 30, each substrate comprises the upper surface and the lower surface opposite to each other, and the lower surface of the first substrate 10 and the upper surface 201 of the second substrate 20 are adjacent to each other; the lower surface of the first substrate 10 and the upper surface of the second substrate 20 are both provided with pads, the pads on the lower surface of the first substrate are in one-to-one correspondence with the electrical networks of pads on the upper surface of the second substrate, and the first substrate 10 and the second substrate 20 are fixed and electrically connected by means of the pads. The lower surface of the second substrate 20 and the upper surface 301 of the third substrate 30 are adjacent to each other. The magnetic core 21 comprises the upper magnetic cover 21a, the lower magnetic cover 21b, the first magnetic column 22 and the second magnetic column 23; the second substrate 20 comprises holes 212 and 213 for respectively allowing the first magnetic column 22 and the second magnetic column 23 to pass through, such that the magnetic core 21 is assembled to the second substrate 20. After the magnetic core 21 is assembled to the second substrate 20, the magnetic core 21 comprises the first side 201 and the third side 203 opposite to each other, the second side 202 and the fourth side 204 opposite to each other, and the four side positions satisfy a clockwise relationship; further, a second side 202 of the magnetic core 21 adjoins an outer side of the magnetic column 22, and the fourth side 204 of the magnetic core 21 adjoins an outer side of the magnetic column 23. The channel between the magnetic columns 22 and 23 is a winding channel 24. The winding channel 24 penetrates the first side 201 and the third side 203. The first substrate 10 comprises a hollow hole 11, and the hollow hole 11 is located at a position close to the center of the first substrate 10. After the first substrate 10 and the second substrate 20 are assembled, the upper magnetic cover 21a of the magnetic core 21 is exposed by means of the hollow hole 11. The height difference between a top surface of the upper magnetic cover 21a and a top surface of the switch can be reduced, thereby reducing the upward thermal resistance of the power conversion device, reducing the working temperature of the magnetic core, and reducing the loss on the magnetic core.

The upper switch Q1&Q2, the middle switch Q3&Q4 and the lower switch SR1&SR2 are all disposed on the upper surface 101 of the first substrate 10, wherein the upper switch Q1 and the middle switch Q3 are disposed along and adjoin the first side 201 of the magnetic core, and the upper switch Q2 and the middle switch Q4 are disposed along and adjoin the third side 203 of the magnetic core; both the upper switches Q1 and Q2 are disposed adjacent to the second side 202 of the magnetic core, both the middle switch Q3 and Q4 are disposed adjacent to the fourth side 204 of the magnetic core. The two groups of lower switch assemblies are respectively disposed along and adjoin the second side 202 and the fourth side 204 of the adjacent magnetic core, that is, the first lower switch SR1 and the second lower switch SR2 in the first lower switch assembly are disposed along and adjoin the second side 202 of the adjacent magnetic core, and the first lower switch SR1 and the second lower switch SR2 in the second lower switch assembly are disposed along and adjoin the fourth side 204 of the adjacent magnetic core; the first lower switch SR1 in each lower switch assembly is disposed adjacent to the third side 203, and the second lower switch SR2 in each lower switch assembly is disposed adjacent to the first side 201. The output capacitors Co adjoin the sources of the first lower switch assembly and the second lower switch assembly, respectively, so that the output capacitor Co, the first lower switch assembly, the magnetic column 22 of the magnetic core 21, the magnetic column 23 of the magnetic core 21, the second lower switch assembly, and the output capacitor are disposed in side-by-side and adjoin each other; in the present embodiment, the first lower switch assembly and the second lower switch assembly are both disposed between the output capacitor and the magnetic column of the magnetic core, but not limited thereto.

On the lower surface of the second substrate 20, a third lower switch assembly is disposed at the second side 202 adjoining the magnetic core, and the third lower switch assembly is vertically corresponding to the first lower switch assembly. In detail, the lower switch SR1 in the third lower switch assembly is vertically corresponding to the lower switch SR1 in the first lower switch assembly, and the lower switch SR2 in the third lower switch assembly is vertically corresponding to the lower switch SR2 in the first lower switch assembly. A fourth lower switch assembly is disposed at a position adjoining the fourth side 204 of the magnetic core, and the fourth lower switch assembly is vertically corresponding to the second lower switch assembly, the lower switch SR1 in the fourth lower switch assembly is vertically corresponding to the lower switch SR1 in the second lower switch assembly, and the lower switch SR2 in the fourth lower switch assembly is vertically corresponding to the lower switch SR2 in the second lower switch assembly. An output positive connection part (i.e. the output positive terminal Vo+) and a ground connection part (i.e. the ground terminal G) are respectively disposed adjacent to the positive electrode and the negative electrode of the output capacitor Co, and are electrically connected to the positive electrode and the negative electrode of the output capacitor Co, respectively. In the present embodiment, the ground connection part, the negative electrode of the output capacitor Co, and the source of the lower switch are disposed nearby and electrically connected; further, the ground connection part adjoins the source of the lower switch and the negative electrode of the output capacitor at the same time. The output positive connection part and the positive electrode of the output capacitor Co are disposed nearby and electrically connected, thereby the length of the power loop is shortened and the parasitic parameters and losses are reduced.

The drain of the upper switch Q1 and Q2 are connected to the pad of the input positive network of the lower surface of the first substrate through the via in the first substrate 10, which are fixed and electrically connected to the pad of the input positive network disposed on the upper surface of the second substrate 20, and are connected to the positive electrode of the input capacitor Cin on the lower surface of the second substrate through the via disposed in the second substrate 20. The negative electrode of the input capacitor Cin is electrically connected to the output positive terminal Vo+. The source of the upper switch Q1 and the drain of the middle switch Q3 are electrically connected to the first upper node SWH1, and is electrically connected to the first upper node pad of the lower surface of the first substrate through the via provided on the first substrate 10; and is fixed and electrically connected to the corresponding first upper node pad on the upper surface of the second substrate 20; and is connected to one end of the resonant capacitor C1 on the lower surface of the second substrate through a via disposed in the second substrate 20, the resonant capacitor C1 is disposed adjacent to the first side 201 of the magnetic core, and the other end of the resonant capacitor C1 is electrically connected to the first end of the first high-voltage winding TW1. The source of the upper switch Q2 and the drain of the middle switch Q4 are electrically connected to the second upper node SWH2, and is electrically connected to the second upper node pad of the lower surface of the first substrate through the via provided on the first substrate 10, and is fixed and electrically connected to the corresponding second upper node pad on the upper surface of the second substrate 20; and is connected to one end of the resonant capacitor C2 on the lower surface of the second substrate through the via provided in the second substrate 20, the resonant capacitor C2 is disposed adjacent to the third side 203 of the magnetic core, and the other end of the resonant capacitor C2 is electrically connected to the first end of the second high-voltage winding TW14.

On the lower surface of the second substrate 20, the input capacitor Cin is vertically disposed corresponding to the upper switches Q1 and Q2, that is, the projections of the input capacitor Cin and the upper switch Q1 on the upper surface of the second substrate 20 at least partially overlap, and the area of the overlapping part at least occupies 30% of the projection area of the upper switch Q1; the projections of the input capacitor Cin and the upper switch Q2 on the upper surface of the second substrate 20 is at least partially overlapped, and the area of the overlapping part at least occupies 30% of the projection area of the upper switch Q2; the following vertical correspondence all conform to the aforementioned definition. The resonant capacitors C1 and C2 are respectively disposed vertically corresponding to the middle switches Q3 and Q4. The output positive connection parts are respectively disposed at four corners of the lower surface of the second substrate 20, and are symmetrically disposed on two opposite sides of the lower switch assembly; the output positive connection part may be the metal column, wherein the copper column is optimal; or may be a multi-pin connector. In the present embodiment, a 4-pin connector is used as an example, and two connection parts of the 4-pin connector and the copper column are used. In other embodiments, only the metal column or the multi-pin connector is used. The ground connection part is disposed on a lower surface of the second substrate 20, and is respectively disposed on two opposite sides of the lower switch assembly, that is, according to the order of the ground connection part, the first lower switch, the second lower switch, and the ground connection part, along the second side or the fourth side of the magnetic core 21. Further, according to the order of the output positive connection part, the ground connection part, the first lower switch, the second lower switch, the ground connection part and the output positive connection part, they are disposed along the second side or the fourth side of the magnetic core 21.

Referring to the winding manners of FIGS. 5A-FIG. 5D, FIG. 5A and 5B are winding manners of the first high-voltage winding TW1 and the second high-voltage winding TW14, and FIG. 5C and FIG. 5D are winding manners of the first low-voltage winding TW12 and the second low-voltage winding TW13. The first end (i.e. the connection point SWH1_1) of the first high-voltage winding TW11 adjoins the winding channel of the first side 201 of the magnetic core, and the first end (i.e. the connection point SWH2_1) of the second high-voltage winding TW14 adjoins the winding channel of the third side 203 of the magnetic core. A winding method of the first high-voltage winding TW11 from the first end to the second end (SWL2) is: firstly, passing through the winding channel 24 from bottom to top, and then the winding is divided into two branches, wherein one of the branches is wound around the magnetic column 22 in a counterclockwise direction for at least one circle, then reaching the second lower node SWL2 adjoining the second side 202 of the magnetic core 21; the other branch is wound around the magnetic column 23 in a clockwise direction for at least one circle, then reaching the second lower node SWL2 adjoining the fourth side 204 of the magnetic core 21. A winding method of the second high-voltage winding TW12 from the first end to the second end (SWL1) is: firstly, passing through the winding channel 24 from top to bottom, then the winding is divided into two branches, one of the branches is wound around the magnetic column 22 in the clockwise direction for at least one circle, and reaching the first lower node SWL1 adjoining the second side 202 of the magnetic core 21; the other branch is wound around the magnetic column 23 in the counterclockwise direction for at least one circle, then reaching the first lower node SWL1 adjoining the fourth side 204 of the magnetic core 21.

The drain of the first lower switch SR1 and the source of the first middle switch Q3 are electrically connected to the first lower node SWL1; since the two first lower switches SR1 are respectively disposed on the second side 202 and the fourth side 204 of the magnetic core, the first lower node SWL1 is converged at the opening of the winding channel 24 of the third side (i.e. the first end of the first low-voltage winding TW13) from the second side 202 and the fourth side 204 respectively and along the third side 203 of the magnetic core, and passing through the winding channel 24 to the second end of the first low-voltage winding on the first side; and then, reaching the output positive terminal Vo+ on the second side 202 and the fourth side 204 of the magnetic core along the first side 201 respectively. The drain of the second lower switch SR2 and the source of the second middle switch Q4 are electrically connected to the second lower node SWL2; since the two second lower switches SR2 are respectively disposed on the second side 202 and the fourth side 204 of the magnetic core, the second lower node SWL2 is converged at the opening of the winding channel 24 of the first side (i.e. the first end of the second low-voltage winding TW12) from the second side 202 and the fourth side 204 respectively and along the first side 201 of the magnetic core, and passing through the winding channel 24 to the second end of the second low-voltage winding on the third side; and then, along the third side 203 of the magnetic core, respectively reaching the output positive terminal Vo+ on the second side 202 and the fourth side 204 of the magnetic core. The switch arrangement matching the winding manner enables the switch to be placed around the magnetic core 21 in 360 degrees, so as to obtain the advantages of a small parasitic resistance of the winding, a large number of lower switches, and a small on-resistance.

The power conversion device disclosed in the present embodiment can also use the assembly process shown in the previous embodiment, and the same technical effect can be obtained.

The switch disclosed by the application can be used for realizing the functions of the switch disclosed by the application, such as a Si MOSFET, SiC MOSFET, GaN MOSFET or IGBT MOSFET.

The power supply module device according to the embodiment can be an independent module or a part of the electronic device, and can meet the technical features and advantages disclosed by the application.

The " equal " or " same " or " equal to " disclosed by the application needs to consider the parameter distribution of engineering, and the error distribution is within +/-30%; and the included angle between the two line segments or the two straight lines is less than or equal to 45 degrees; the included angle between the two line segments or the two straight lines is within the range of [ 60, 120 ]; and the definition of the phase error phase also needs to consider the parameter distribution of the engineering, and the error distribution of the phase error degree is within +/-30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A power conversion device, comprising a switch, a magnetic core, a first substrate and a second substrate; the magnetic core comprises an upper magnetic cover, a lower magnetic cover, a first magnetic column and a second magnetic column; the second substrate comprises an upper surface and a lower surface opposite to each other, and holes; the holes penetrate through the upper surface and the lower surface of the second substrate and respectively allow the first magnetic column and the second magnetic column to pass through; the upper magnetic cover and the lower magnetic cover are respectively assembled from the upper surface and the lower surface of the second substrate;
the first substrate comprises a hollow part, an upper surface and a lower surface opposite to each other, the lower surface of the first substrate is disposed adjacent to the upper surface of the second substrate, and after the first substrate, the magnetic core and the second substrate are assembled, the upper magnetic cover of the magnetic core is exposed on the upper surface of the first substrate;
the switch is disposed on the upper surface of the first substrate.

2. The power conversion device of claim 1, further comprising an input positive terminal, an output positive terminal, a ground terminal, an input capacitor and an output capacitor, wherein the input positive terminal, the output positive terminal, the ground terminal and the input capacitor are all disposed on the lower surface of the second substrate; a positive electrode of the input capacitor is electrically connected to the input positive terminal, and a negative electrode of the input capacitor is electrically connected to the output positive terminal.

3. The power conversion device of claim 2, wherein the switch comprises an upper switch, a middle switch and a lower switch; the upper switch, the middle switch and the lower switch are sequentially connected in series and then connected between the input positive terminal and the ground terminal.

4. The power conversion device of claim 3, wherein the lower switch is further disposed on the lower surface of the second substrate, and a position of the lower switch disposed on the lower surface of the second substrate is in one-to-one correspondence with the position of the lower switch disposed on the upper surface of the first substrate.

5. The power conversion device of claim 4, wherein the magnetic core comprises a first side and a third side opposite to each other, a second side and a fourth side opposite to each other, a channel between the first magnetic column and the second magnetic column is a winding channel, and the winding channel penetrates the first side and the third side.

6. The power conversion device of claim 3, wherein the output capacitor is disposed on the upper surface of the first substrate and between the lower switch and the middle switch.

7. The power conversion device of claim 5, wherein the upper switch, the middle switch, and the lower switch are all disposed on the first side of the magnetic core, and the lower switch is adjacent to the first side of the magnetic core.

8. The power conversion device of claim 7, wherein the lower switch comprises two first lower switches and two second lower switches, the two second lower switches are disposed adjacent to the winding channel, and the two second lower switches are disposed between the two first lower switches.

9. The power conversion device of claim 3, wherein the lower surface of the first substrate is provided with an input positive terminal pad, and a drain of the upper switch is electrically connected to the input positive terminal pad through a via embedded in the first substrate; the upper surface of the second substrate is also provided with the input positive terminal pad, and the input positive terminal pad disposed on the upper surface of the second substrate is in one-to-one correspondence with the input positive terminal pad disposed on the lower surface of the first substrate.

10. The power conversion device of claim 5, wherein the upper switch comprises a first upper switch and a second upper switch; the middle switch comprises a first middle switch and a second middle switch; the lower switch comprises a first lower switch and a second lower switch; the first upper switch and the first middle switch are disposed along and adjoin the first side of the magnetic core; the second upper switch and the second middle switch are disposed along and adjoin the third side of the magnetic core; the first upper switch and the second upper switch are both disposed adjacent to the second side of the magnetic core, and both the first middle switch and the second middle switch are disposed adjacent to the fourth side of the magnetic core.

11. The power conversion device of claim 10, wherein one of first lower switches and one of second lower switches form a lower switch assembly, and the lower switch assembly comprises a first lower switch assembly and a second lower switch assembly; the first lower switch assembly is disposed along and adjoin the second side of the magnetic core, and the second lower switch assembly is disposed along and adjoin the fourth side of the magnetic core; the first lower switch in each lower switch assembly is disposed adjacent to the third side of the magnetic core, and the second lower switch in each lower switch assembly is disposed adjacent to the first side of the magnetic core.

12. The power conversion device of claim 11, wherein each of the first magnetic column and the second magnetic column comprises an inner side and an outer side; the second side of the magnetic core adjoins the outer side of the first magnetic column, and the fourth side of the magnetic core adjoins the outer side of the second magnetic column; and the first lower switch assembly, the first magnetic column, the second magnetic column, and the second lower switch assembly are disposed in side-by-side and adjoin each other.

13. The power conversion device of claim 12, wherein the output capacitor respectively adjoins sources of the first lower switch assembly and the second lower switch assembly; the output capacitor, the first lower switch assembly, the first magnetic column, the second magnetic column, the second lower switch assembly, and the output capacitor are disposed in side-by-side and are adjoins each other.

14. The power conversion device of claim 13, wherein the lower surface of the second substrate is provided with a third lower switch assembly and a fourth lower switch assembly, and the third lower switch assembly and the fourth lower switch assembly are respectively vertically corresponding to the first lower switch assembly and the second lower switch assembly.

15. The power conversion device of claim 1, wherein the hollow part is a hollow groove disposed adjacent to one of sides of the first substrate.

16. The power conversion device of claim 1 wherein the hollow part is a hollow hole located at a position close to a center of the first substrate.

17. The power conversion device of claim 2, further comprising a third substrate, wherein the third substrate comprises an upper surface and a lower surface opposite to each other; the upper surface of the third substrate is disposed adjacent to the lower surface of the second substrate; the upper surface of the third substrate is provided with a pin pad, the pin pad is electrically connected to the input positive terminal, the output positive terminal, and the ground terminal; the lower surface of the third substrate is provided with a pin, and the pin is used for being electrically connected to an external assembly.

18. An assembly process flow of the power conversion device of claim 17, comprising the following steps:
step 1: welding a device on the lower surface of the second substrate, and assembling the magnetic core; meanwhile, completing assembly of the third substrate; and assembling all devices on the upper surface of the first substrate together using SMD;
step 2: the assembled second substrate of step 1 and the third substrate are assembled together using SMD;
step 3: an assembly assembled by step 2 and an assembly assembled by step 1 are welded together using SMD.

19. A power conversion device, comprising an input&output terminal, a switch, an output capacitor, and a magnetic assembly; the input&output terminal comprises an input positive terminal, an output positive terminal and a ground terminal, and the output capacitor is connected across the output positive terminal and the ground terminal; the switch comprises an upper switch, a middle switch and a lower switch; the upper switch comprises a first upper switch and a second upper switch; the middle switch comprises a first middle switch and a second middle switch; the lower switch comprises a first lower switch and a second lower switch;
the first upper switch, the first middle switch and the first lower switch constitute a first three-switch bridge arm, the first upper switch and the first middle switch are electrically connected to a first upper node, and the first middle switch and the first lower switch are electrically connected to a first lower node; the second upper switch, the second middle switch and the second lower switch constitute a second three-switch bridge arm, the second upper switch and the second middle switch are electrically connected to a second upper node, and the second middle switch and the second lower switch are electrically connected to a second lower node; the magnetic assembly is at least electrically connected to the first lower node, the second lower node, and the output positive terminal;
wherein the power conversion device further comprises a first substrate, the upper switch, the middle switch, the lower switch, and the output capacitor are disposed on the first substrate, and the output capacitor is disposed between the lower switch and the middle switch.

20. The power conversion device of claim 19, wherein the magnetic assembly comprises a magnetic core and a winding; the magnetic core comprises a first magnetic column and a second magnetic column, a channel between the first magnetic column and the second magnetic column is a winding channel, and the winding channel penetrates two opposite sides of the magnetic core; the winding passes through the winding channel, and the lower switch is disposed adjacent to the winding channel.

21. The power conversion device of claim 20, wherein the magnetic core comprises an upper magnetic cover and a lower magnetic cover; the winding comprises a first high-voltage winding, a second high-voltage winding, a first low-voltage winding, and a second low-voltage winding; each of the first high-voltage winding, the second high-voltage winding, the first low-voltage winding, and the second low-voltage winding comprises a first end and a second end; the second end of the first low-voltage winding is electrically connected to the second end of the second low-voltage winding.

22. The power conversion device of claim 21, wherein the second end of the first high-voltage winding is electrically connected to the first end of the second low-voltage winding; the second end of the second high-voltage winding is electrically connected to the first end of the first low-voltage winding.

23. The power conversion device of claim 22, wherein each of the first high-voltage winding, the second high-voltage winding, the first low-voltage winding and the second low-voltage winding is wound around the first magnetic column and the second magnetic column, and a winding direction on the first magnetic column is opposite to a winding direction on the second magnetic column; a winding direction of the first high-voltage winding is opposite to a winding direction of the second high-voltage winding on a same magnetic column of the first and second magnetic columns, and a winding direction of the first low-voltage winding is opposite to a winding direction of the second low-voltage winding on a same magnetic column of the first and second magnetic columns.

24. The power conversion device of claim 19, wherein the switch and the input&output terminal are disposed on different planes; a setting position of the input positive terminal is in one-to-one correspondence with a setting position of the upper switch; a setting position of the ground terminal is in one-to-one correspondence with a setting position of the lower switch.

25. The power conversion device of claim 19, further comprising an input capacitor, wherein a setting position of the input capacitor is in one-to-one correspondence with a setting position of the upper switch.

26. A magnetic assembly, comprising a magnetic core, a first high-voltage winding, a second high-voltage winding, a first low-voltage winding, and a second low-voltage winding; each of the first high-voltage winding, the second high-voltage winding, the first low-voltage winding, and the second low-voltage winding comprises a first end and a second end; the second end of the first low-voltage winding is electrically connected to the second end of the second low-voltage winding; the magnetic core comprises an upper magnetic cover, a lower magnetic cover, a first magnetic column and a second magnetic column; each of the first high-voltage winding, the second high-voltage winding, the first low-voltage winding and the second low-voltage winding is wound around the first magnetic column and the second magnetic column, and a winding direction on the first magnetic column is opposite to a winding direction on the second magnetic column; a winding direction of the first high-voltage winding is opposite to a winding direction of the second high-voltage winding on a same magnetic column of the first magnetic column and the second magnetic column, and a winding direction of the first low-voltage winding is opposite to a winding direction of the second low-voltage winding on a same magnetic column of the first magnetic column and the second magnetic column.

27. The magnetic assembly of claim 26, wherein the magnetic core comprises a first side and a third side opposite to each other, a second side and a fourth side opposite to each other; a channel between the first magnetic column and the second magnetic column is a winding channel, and the winding channel penetrates the first side and the third side.

28. The magnetic assembly of claim 27, wherein the first end and the second end of each of the first high-voltage winding, the second high-voltage winding, the first low-voltage winding, and the second low-voltage winding are disposed adjacent to a same side of the magnetic core.

29. The magnetic assembly of claim 28, wherein a winding method from the first end to the second end of the first low-voltage winding is: firstly, the first low-voltage winding is divided into two paths, respectively surrounding the magnetic core from two sides of the magnetic core, and reaching the third side of the magnetic core from the first side of the magnetic core; then after converging, passing through the winding channel from the third side of the magnetic core to the first side of the magnetic core.

30. The magnetic assembly of claim 29, wherein a winding method from the first end to the second end of the second low-voltage winding is: firstly, passing through the winding channel from the first side of the magnetic core, reaching the third side of the magnetic core, then the second low-voltage winding is divided into two paths, respectively surrounding the magnetic core from two sides of the magnetic core, reaching the first side of the magnetic core.

31. The magnetic assembly of claim 30, wherein the first and second high-voltage windings and the first and second low-voltage windings are disposed on a substrate; a winding method from the first end to the second end of the first high-voltage winding is: firstly, on a first layer of the substrate, passing through the winding channel from the first side to the third side of the magnetic core, then the first high-voltage winding is divided into two paths, respectively surrounding the magnetic core from two sides of the magnetic core, returning to the first side of the magnetic core, and then reaching a second layer of the substrate through a via; on the second layer, passing through the winding channel from the first side of the magnetic core to the third side of the magnetic core, then the first high-voltage winding is divided into two paths, respectively surrounding the magnetic core from two sides of the magnetic core, returning to the first side of the magnetic core.

32. The magnetic assembly of claim 31, wherein a winding method from the first end to the second end of the second high-voltage winding is: firstly, on a third layer of the substrate, the second high-voltage winding is divided into two paths, respectively surrounding the magnetic core from two sides of the magnetic core, reaching the third side of the magnetic core from the first side of the magnetic core; then after converging, passing through the winding channel from the third side of the magnetic core to the first side of the magnetic core, and then reaching to a fourth layer of the substrate through a via; on the fourth layer, the second high-voltage winding is divided into two paths, respectively surrounding the magnetic core from two sides of the magnetic core, reaching the third side of the magnetic core from the first side of the magnetic core; then after converging, passing through the winding channel again from the third side of the magnetic core to the first side of the magnetic core.

33. The magnetic assembly of claim 27, wherein the first end of the first low-voltage winding is located on the second side and the fourth side of the magnetic core; the second end of the first low-voltage winding is located on the second side and the fourth side of the magnetic core; the first end of the second low-voltage winding is located on the second side and the fourth side of the magnetic core; and the second end of the second low-voltage winding is located on the second side and the fourth side of the magnetic core.

34. The magnetic assembly of claim 33, wherein the first end of the first high-voltage winding adjoins the winding channel on the first side of the magnetic core; the first end of the second high-voltage winding adjoins the winding channel of the third side of the magnetic core; the second end of the first high-voltage winding respectively adjoins the second side of the magnetic core and the fourth side of the magnetic core; and the second end of the second high-voltage winding respectively adjoins the second side of the magnetic core and the fourth side of the magnetic core.

35. The magnetic assembly of claim 34, wherein a winding method from the first end to the second end of the first low-voltage winding is: from the second side of the magnetic core and the fourth side of the magnetic core respectively and along the third side, the first low-voltage winding is converged at an opening of the winding channel of the third side of the magnetic core, passing through the winding channel and reaching the first side of the magnetic core; and then, the first low-voltage winding is divided into two paths and reaching the second side and the fourth side of the magnetic core respectively along the first side of the magnetic core.

36. The magnetic assembly of claim 35, wherein a winding method from the first end to the second end of the first low-voltage winding is: from the second side and the fourth side of the magnetic core respectively and along the first side of the magnetic core, the first low-voltage winding is converged at the opening of the winding channel of the first side of the magnetic core, passing through the winding channel and reaching the third side of the magnetic core; and then, the first low-voltage winding is divided into two paths, reaching the second side and the fourth side of the magnetic core respectively along the third side of the magnetic core.

37. The magnetic assembly of claim 36, wherein a winding method from the first end to the second end of the first high-voltage winding is: firstly, passing through the winding channel from bottom to top, and then the first high-voltage winding is divided into two branches, wherein one of the branches is wound around the first magnetic column in a counterclockwise direction for at least one circle, then reaching and adjoining the second side of the magnetic core; the other branch is wound around the second magnetic column in a clockwise direction for at least one circle, then reaching and adjoining the fourth side of the magnetic core.

38. The magnetic assembly of claim 37, wherein a winding method from the first end to the second end of the second high-voltage winding is: firstly, passing through the winding channel from top to bottom, then dividing into two branches, one of the branches of the winding channel is wound around the first magnetic column in the clockwise direction for at least one circle, then reaching and adjoining the second side of the magnetic core; the other branch of the winding channel is wound around the second magnetic column in the counterclockwise direction for at least one circle, then reaching and adjoining the fourth side of the magnetic core.

39. The magnetic assembly of claim 26, wherein the second end of the first high-voltage winding is connected to the first end of the second low-voltage winding; and the second end of the second high-voltage winding is connected to the first end of the first low-voltage winding.
